(19) United States
(12) Patent Application Publication
(10) Pub. No.: US 2007/0209870 A1
(43) Pub. Date: Sep. 13, 2007

(54) Access and escape devices

(76) Inventor: Brian Johnson, Portland, OR (US)

Correspondence Address: ATER WYNNE LLP, 222 SW COLUMBIA, SUITE 1800, PORTLAND, OR, 97201-6618, US

(21) Appl. No.: 11/603,378

(22) Filed: Nov. 21, 2006

Related U.S. Application Data
(60) Provisional application No. 60/782,253, filed on Mar. 13, 2006.

(51) Int. Cl. A62B 1/20

(52) U.S. Cl. 182/49

(57) ABSTRACT

To provide another way to exit and/or enter a building, the multiple-story building may include alternative access devices. For example, some of the windows on the upper floors may be equipped with devices to allow occupants of those floors to exit and/or enter the building via the window. The devices may be integrated with the building. Alternatively, or additionally, the devices may be portable and installed when needed, such as during an emergency. The alternative access devices also may be used for other applications. For example, the devices may provide access to a structure that is a considerable distance from the ground, such as a tree house or other play structure. The invented access device includes a chute mounted at the top to a pivotal frame mounted near a window or other elevated opening, the chute having a connected or independently deployable step ladder therein and optionally spaced apart support members such as circular, rectangular or oval hoops therearound. The rungs of the step ladder provide a standoff for the webbed material of the chute. Stowage can be in an interior wall of an elevated structure and deployment can be semi-automatic, reliable and smooth.

### RELATED APPLICATIONS

The present application claims priority to U.S. Provisional Patent Application Ser. No. 60/782,253, entitled ACCESS DEVICES and filed Mar. 13, 2006, the disclosure of which is incorporated herein in its entirety by this reference.

### BACKGROUND OF THE INVENTION

This invention relates generally to the field of access devices for ingress and/or egress to and/or from elevated structures. More particularly, it concerns access devices useful as emergency escapes from upper floors of buildings and/or for getting into and/or out of tree houses and/or other play structures.

Multiple-story buildings typically include doors or other access areas on the main floor, which usually is the first floor of the building. To access the upper floors, people typically use the stairs and/or elevators found in the building. Conversely, people on the upper floors use the stairs and/or elevators so that they can access the main floor, such as to exit the building. However, in the event of an emergency (such as a fire), the stairs or elevator may not be accessible or operable. Thus, people on the upper floors may be unable to safely access the main floor to exit the building.

### SUMMARY OF THE INVENTION

To provide another way to exit and/or enter a building, the multiple-story building may include alternative access devices. For example, some of the windows on the upper floors may be equipped with devices to allow occupants of those floors to exit and/or enter the building via the window. The devices may be integrated with the building. Alternatively, or additionally, the devices may be portable and installed when needed, such as during an emergency. The alternative access devices also may be used for other applications. For example, the devices may provide access to a structure that is a considerable distance from the ground, such as a tree house or other play structure. The invented access device includes a chute mounted at the top to a pivotal frame mounted near a window or other elevated opening, the chute having a connected or independently deployable step ladder therein and optionally spaced apart support members such as circular, rectangular or oval hoops therearound. The rungs of the step ladder provide a standoff for the webbed material of the chute. Stowage can be in an interior wall of an elevated structure and deployment can be semi-automatic, reliable and smooth.

### BRIEF DESCRIPTION OF THE DRAWINGS

FIG. 1 is an isometric view of an example of an access device installed on an upper-story window. Those of skill in the art will appreciate that the isometric view is with a gaze upward from the ground or landing on which the user would alight after descending.

FIG. 2 is a partial isometric view of the access device of FIG. 1, showing an attachment mechanism engaging the upper-story window.

FIG. 3 is a partial isometric view of the access device of FIG. 1, showing a portion of the attachment mechanism in a detached position.

FIGS. 4-6 are isometric views of a method of storing the access device of FIG. 1, shown detached from an upper-story window and without an access structure.

FIGS. 7-10 are top plan views of the access device of FIG. 1, wherein FIGS. 8 and 10 represent fragmentary details respectively of the device shown in FIGS. 7 and 9.

FIGS. 11-16 are side elevations illustrating a method of installing the access device of FIG. 1.

FIG. 17 is an isometric view of another example of an access device housed in a door frame.

FIG. 18 is a different isometric view of the access device of FIG. 17 taken from above and from the outside thereof with the exterior door closed.

FIG. 19 is an isometric view of the access device of FIG. 17, with the interior and exterior doors open and with the frame pivoted outwardly to a horizontal, partly deployed position.

FIG. 20 is an isometric view of the access device of FIG. 17, with the interior and exterior doors partly open and with the frame pivoted to a vertical, stowed position.

FIG. 21 is an isometric view of the access device of FIG. 17, with the exterior door open and with the frame pivoted to an intermediate, outwardly angled position.

FIG. 22 is a fragmentary isometric view of the access device of FIG. 17, with the exterior door open and with the frame pivoted to a horizontal, fully deployed position in which the chute and ladder extend to their full length. Those of skill in the art will appreciate that the fragmentary isometric view is with a gaze upward from the ground or landing on which the user would light when descending.

FIG. 23 is an isometric view of the interior door closed.

FIG. 24 is an isometric view of the exterior of an upper story of a house in which the access device of FIG. 17 is installed.

FIG. 25 is an isometric view corresponding with FIG. 24, but with the access device in accordance with the third embodiment of the invention fully deployed and featuring a user standing on the seventh rung of the ladder within the oval chute. Those of skill in the art will appreciate that the isometric view is with a gaze upward from the ground or landing on which the user would alight after descending.

FIGS. 26A and 26B are close-up illustrations of a ladder rung's stand-off in an end view, with FIG. 26A showing the stand-off at rest and with FIG. 26B showing the stand-off in its pivotally rotated active orientation when bearing the weight of the user.

FIG. 27 is a front elevation of the access device in accordance with a third embodiment of the invention in which oval hoops are visibly stowed within a frame in an opening beside the open external door.

FIG. 28 is a front elevation of the third embodiment of the invention stowed and neatly dressed behind the external door.

FIG. 29 is an isometric view of the bottom of the access device in accordance with the third embodiment of the invention, and features the deployed ladder within the oval-hooped chute and the triangular ladder pull structure at its deployed base.

FIG. 30 is an isometric view of a fourth embodiment of the invention corresponding with FIG. 1 in which there are no hoops but in which the ladder is connected to the chute semi-permanently by ties to the inside front of the chute at suitable intervals to make the chute and ladder work as one to enable a user to ascend, descend or rest therein. Those of skill in the art will appreciate that the isometric view is with a gaze upward from the ground or landing on which the user would alight after descending.

FIG. 31 is a fragmentary front elevation corresponding generally with FIG. 30 but in which the ladder is connected to the chute only temporarily by hooks that extend laterally from each ladder rung and that deploy through the chute's mesh to affix the chute and ladder when the corresponding rung bears a user's weight.

### DETAILED DESCRIPTION OF THE PREFERRED EMBODIMENTS

The invention in accordance with a preferred embodiment involves an access device stowable in and deployable from an upper extent of a wall of a tall structure, e.g. a building such as a residence, or deployable from an upstairs window thereof, or deployable from a tree house or other elevated play structure. The invented device facilitates sure, quick and safe ingress or egress to and from the elevated structure.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

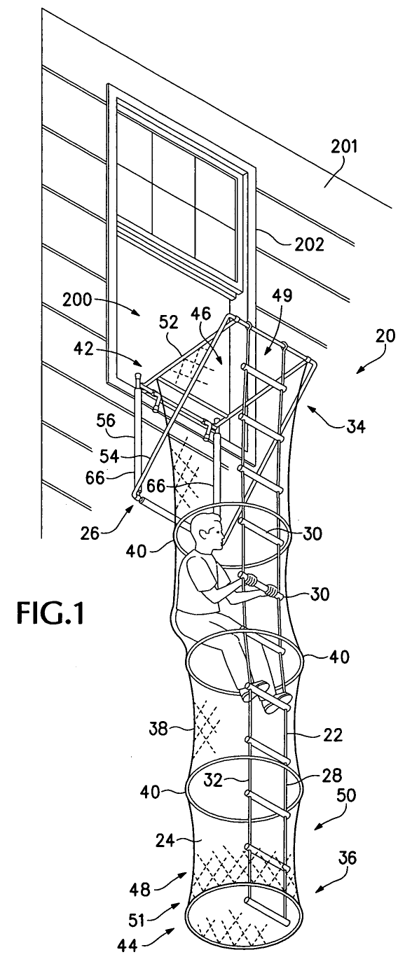

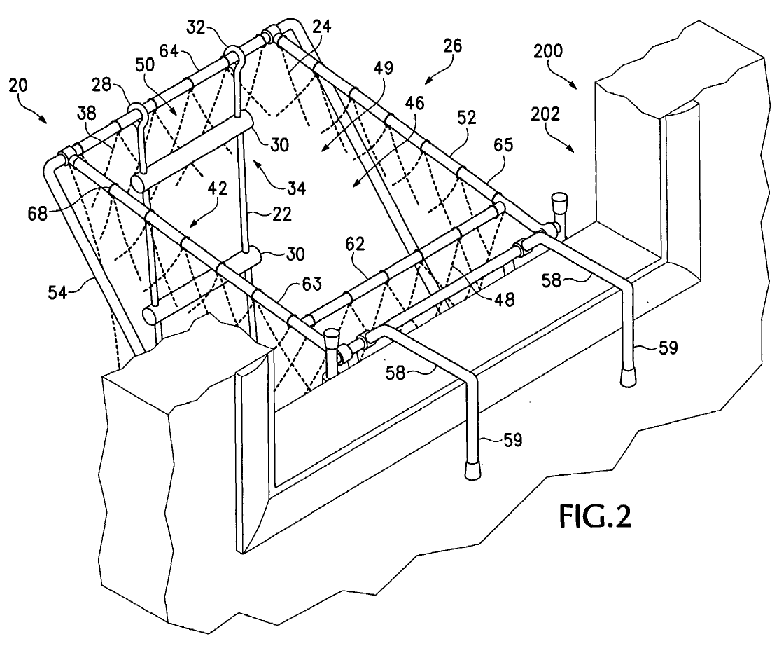

Referring to FIGS. 1-3, an example of an access device 20 is shown installed on an access area 200, such as an upper-story window 202, of a building 201 above the ground or other landing. Generally, “upper story” as used herein refers to an elevated level of a building above such ground or other landing from which it is impossible, difficult and/or undesirable to escape by jumping, climbing or rappelling. Upper story is not limited to a second floor or to any other particular number of floors above the ground or landing. The upper-story window may be any suitable size and/or shape. Additionally, or alternatively, the access device may be installed on other access areas of a building, play structure, or any other suitable structure.

The access device may include an access structure 22, a containment structure 24, and an attachment mechanism 26, as shown in FIG. 1. Access structure 22 may include any suitable structure configured to allow a user to move away and/or towards the access area. For example, access structure 22 may include a ladder or stepladder 28. The ladder may include rungs 30 and support lines 32. Rungs 30 and support lines 32 may be any suitable material. For example, rungs 30 may be made of polyvinyl chloride (PVC), plastic, wood or other material, while support lines 32 may be made of nylon rope or other suitable material.

Additionally, the ladder may include an upper end portion 34 and a lower end portion 36. Upper end portion 34 may be supported by or connected to the attachment mechanism. Lower end portion 36 may be adjacent to or on the ground, or other desired level. Moreover, ladder 28 may include one or more deflecting elements 37 (shown in FIG. 1), which may include any suitable structure configured to maintain the ladder within containment structure 24. The deflecting elements may, for example, prevent ladder 28 from getting entangled with containment structure 24. Deflecting elements may be attached to one or more of rungs 30, and/or any suitable portion of the ladder.

Although ladder 28 is shown to be a rope ladder, any suitable ladder may be used. Additionally, although access structure 22 is shown to include ladder 28, the access structure may include any suitable structure configured to allow a user to move away from and/or towards the access area.

Containment structure 24 may include any suitable structure configured to prevent a user from falling when that user has disengaged from the access structure, such as when the user's hands slip when using the access structure. For example, the containment structure may include a chute 38 and one or more support members 40, as shown in FIG. 1. Chute 38 may include any suitable shape and/or material. For example, the chute may be a netted rope chute with a generally cylindrical shape with a generally rectilinear (e.g. square or rectangular) or curvilinear (e.g. circular, elliptical or oval) cross section. “Cylindrical”, as used herein, refers to a generally closed, elongate, containment structure of any cross-sectional shape that is suitable generally to maintain a user's body's position and orientation therein while the user ascends, descends or rests in the chute.

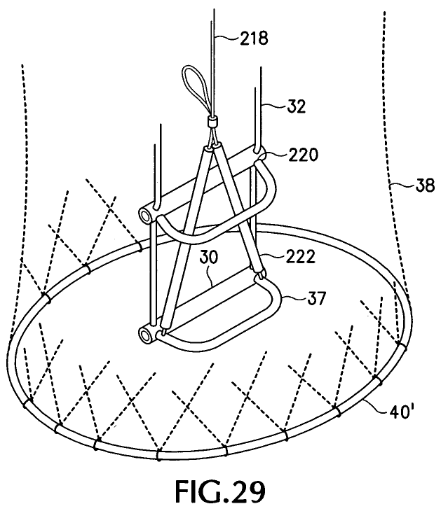

Those of skill in the art will appreciate that, when configured with a cross section that is wider in one axis than in another, e.g. a rectangular, elliptical or oval cross section, chute 38 has greater stability when deployed. This is because the chute when deployed twists a quarter turn as it exits the frame such that its wider expanse naturally rests and/or is urged into a more stable relatively flat orientation against the side of building 201. This advantage will be further explained below by reference to FIGS. 25 and 27-29.

Chute 38 may include an upper end portion 42 and a lower end portion 44. Additionally, the chute may define an interior 46 with a proximal side 48 that is adjacent the building or play structure when access device 20 is installed, and a distal side 50 spaced apart from the proximal side when the device is deployed.

Ladder 28 deploys as illustrated along interior 46 along its distal side 50. This configuration of ladder 28 within chute 38 assists escapes from a burning building such as a house. Because the escapee is facing away from the house when using ladder 28 so deployed along the distal side 50, windows that might explode into glass shards are less likely to risk injury to the escapee's face or vital organs, a concern shared by fire professionals. Moreover, use of ladder 28 so deployed along the chute's distal side tends to leverage the bottom of the chute itself (by the weight of the escapee borne on the rungs of the ladder) away from the burning building, creating some additional safety margin (see FIGS. 1, 30 and 31).

Moreover, the chute may include suitable entry and/or exit openings at suitable portions of the chute. For example, chute 38 may include an upper opening 49 and a lower opening 51. Upper opening 48 may be at the upper end portion of the chute, while lower opening 50 may be adjacent the lower end portion of the chute (such as along a portion of the perimeter of the lower end portion facing the building when access device 20 is attached to upper-story window 202). The lower end portion may be at least substantially closed to contain a user who has disengaged from the access structure.

Although chute 38 is shown to be made of woven/knotted netting rope material with a circular cylindrical shape, the chute may be made of any suitable material and may be any suitable shape. For example, the chute may be made of a cloth or canvas tube, or of another suitable flexible webbed material capable of supporting a load, elongating into a cylindrical shape when deployed and collapsing into a relatively flat shape when stowed, with a square, rectangular, elliptical or oval cross-section. Additionally, although chute 38 is shown to include openings in specific areas, the chute may include openings in any other suitable areas. For example, the lower end portion of the chute may include an opening. Alternatively, the lower end portion of the chute may be generally closed. Within the spirit and scope of the invention the lower end portion of the chute may be normally generally closed but openable, or may be normally open but generally closeable. Such open-ability and close-ability may be provided by appropriate ties, rings, fabrics, contracted or expanded webbing or webbing density, or any other suitable means.

It will be understood that open and closed are relative terms in this context, since one of the embodiments of the invention the lower end portion of the chute itself is formed of an open woven material. Thus, the lower end portion of the chute, within the spirit and scope of the invention, may feature a substantially open woven fabric but nevertheless may be seen to be substantially closed for purposes of supporting the weight and extremities of a user of the device.

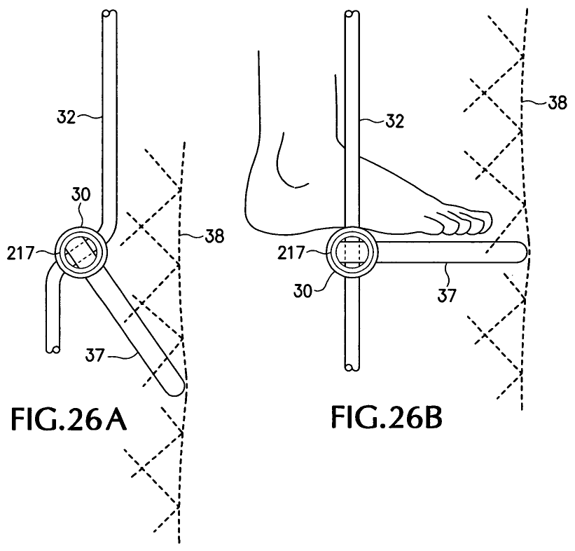

Those of skill in the art will appreciate from FIG. 1 that, when access device 20 is deployed and when a user descends through the interior of chute 38 while using ladder 28, the chute tends to break or bend and to pivot away from building 201 from a point adjacent the user's backside. This leverage places the user's backside pressing against webbed or otherwise flexible periphery of chute 38 to break or slow a fall or slide that might otherwise occur if the user loses his or her hand or foot grip. As will be seen below by reference to FIG. 26, this leverage also creates a moment arm on the rungs of the ladder that ensures safety and room for the user's feet free of inadvertent snagging with the interior of chute 38.

Support members 40 may include any suitable structure configured to support chute 38 in a working configuration, such as an open, generally cylindrical configuration. For example, support members 40 may include segment rings in spaced apart intervals to support the chute. The segment rings may be connected to the chute in any suitable way. For example, the segment rings may weave in and out of the netting material at suitable portion(s) of the chute. Additionally, the segment rings may be made of any substantially rigid material, such as wood, metal, PVC or any other suitable alternative.

Although the segment rings are shown to be circular, the support members may be any suitable shape to support the chute. For example, if the chute has a square or rectangular cross-section, then the segment rings may be square or rectangular. Alternatively, the segment rings or support members may be elliptical or oval or another suitable curvilinear shape. Alternatively, the segment rings or support members may be horseshoe-shaped with one or more ends operatively connected (including loosely attached) to the rope ladder. Additionally, although support members 40 are shown to include discrete and spaced apart segment rings, the support members may be a single continuous support, as by providing a contiguous, webbed material with reinforcement regions that act similarly to the segment rings or support members. Moreover, although containment structure 24 is shown to include chute 38 and support members 40, the containment structure may include any suitable structure configured to prevent a user from falling if the user becomes disengaged from the access structure.

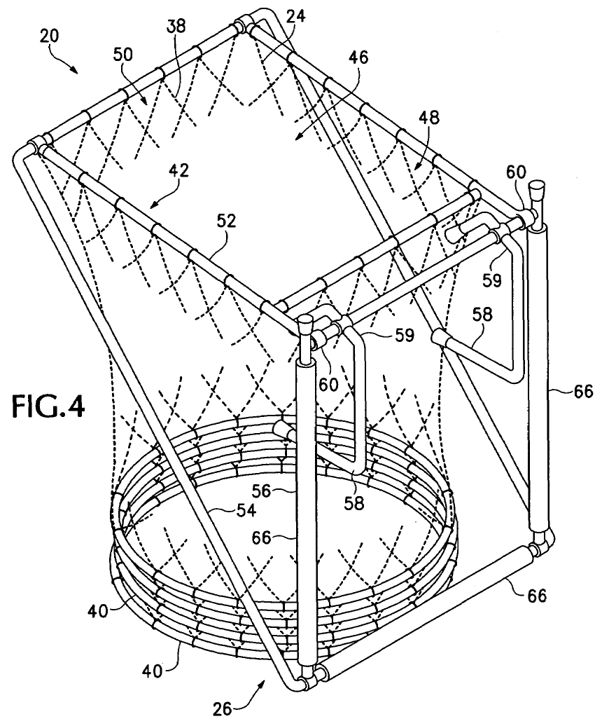

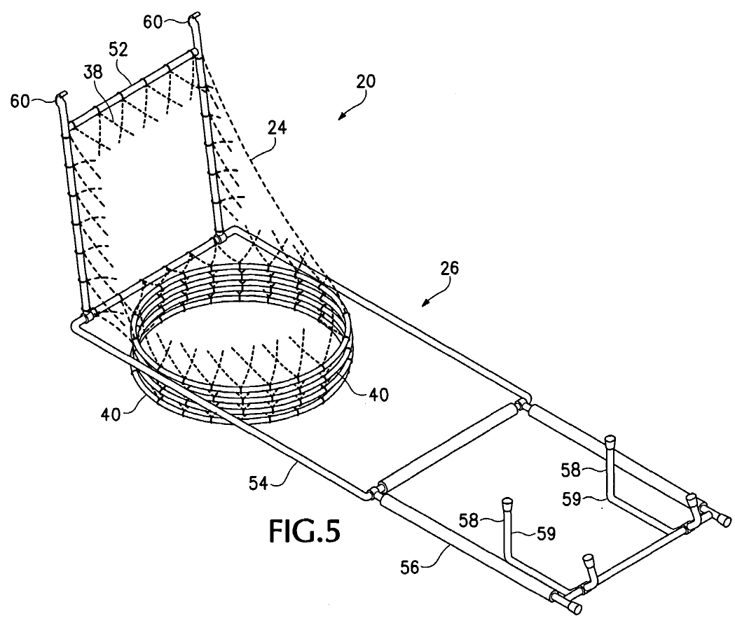

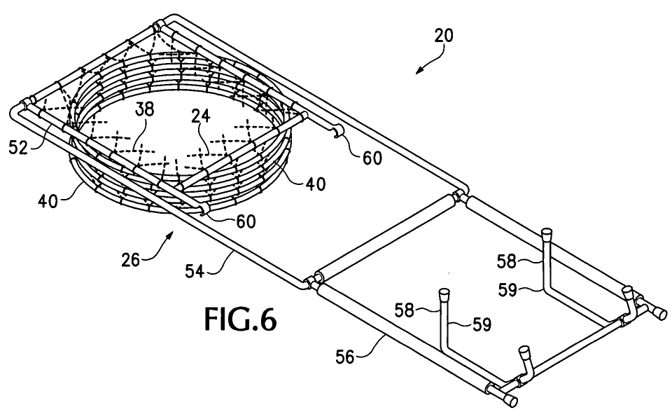

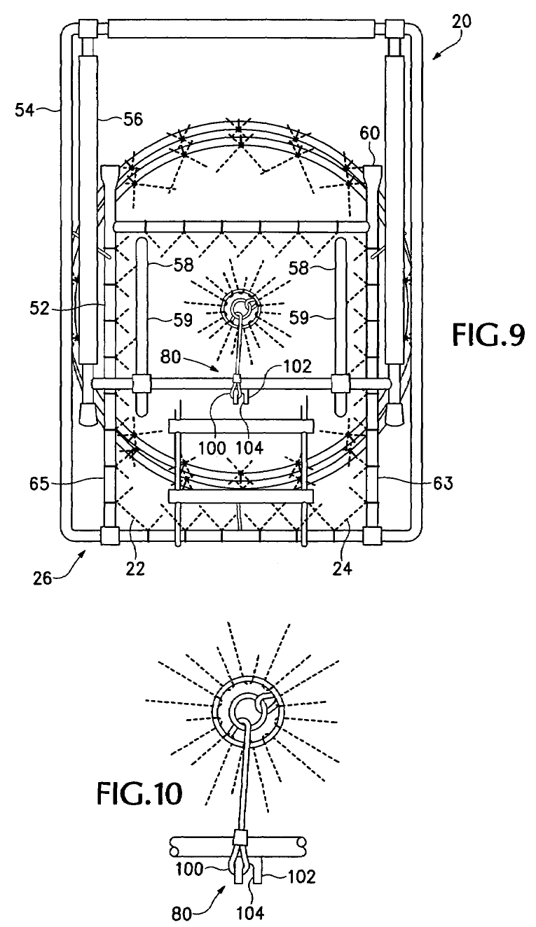

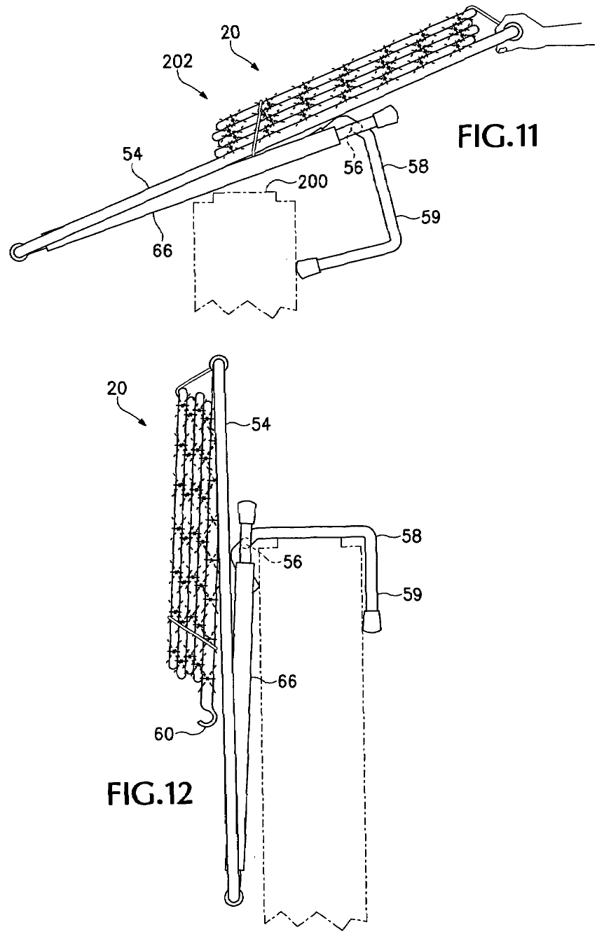

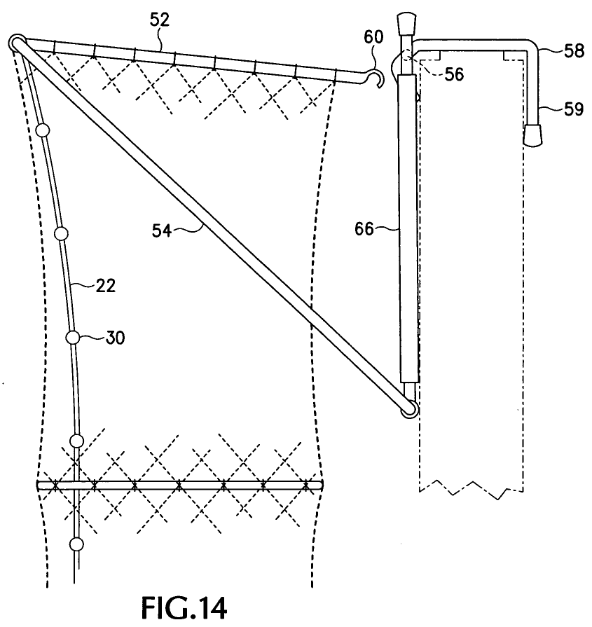

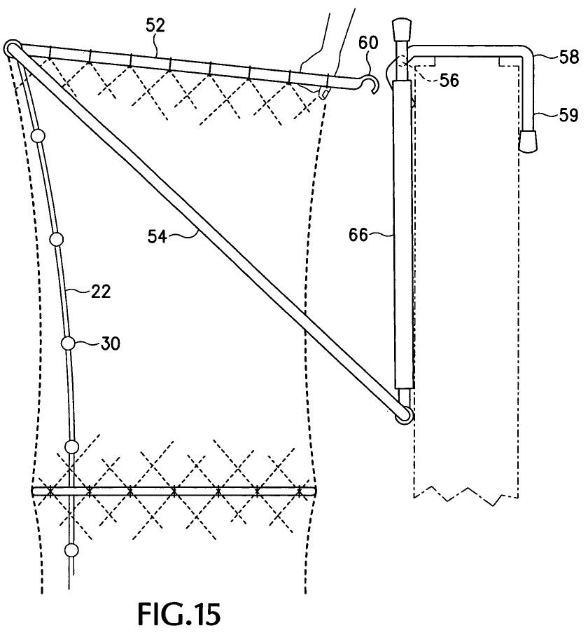

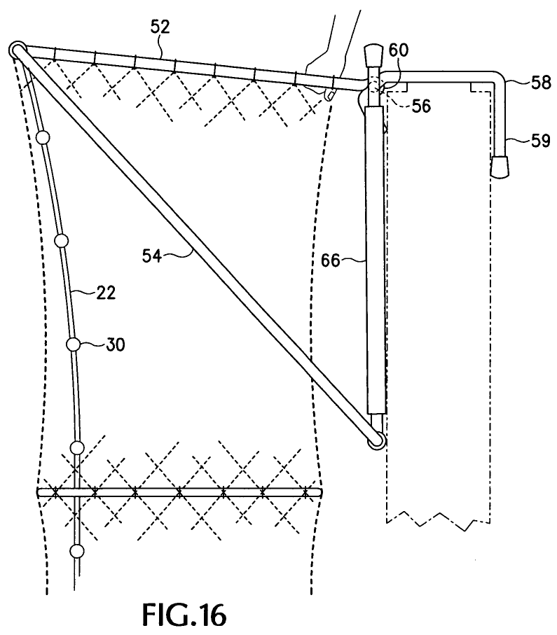

Attachment mechanism 26 may include any suitable structure configured to support the access and/or containment structures from the access area, such as upper-story window 202. For example, the attachment mechanism may include a first support frame 52, a second support frame 54, a third support frame 56, and one or more connectors 58, as shown in FIGS. 1-3. The first, second, and/or third support frames may have any suitable shape(s). For example, those frames may each be at least substantially rectangular in shape. Connectors 58 may include any suitable structure configured to engage a ledge of upper-story window 202 or any suitable access area. For example, connectors 58 may include one or more hooks 59. The connectors may be discrete and/or may pivot independently, as shown in FIGS. 4-10, or may be connected and/or pivot together, as shown in FIGS. 11-16.

First support frame 52 may include one or more engagement members 60 (such as hooks) configured to engage one or more of the other support frames, such as third support frame 56. Additionally, the first support frame may include a proximal bar 62 that is adjacent to the structure when access device 20 is installed, and a distal bar 64 spaced apart from the proximal side when the device is installed. Moreover, first support frame 56 may include side bars 63 and 65.

The first, second, and/or third support frames may be connected to each other in any suitable way to support the access and/or containment structures. For example, the support frames may be connected such that the first support frame may be perpendicular to the building and the third support frame may be parallel to the building when the access device is attached to the upper-story window. First support frame 52 may be pivotally connected to second support frame 54. The second support frame also may be pivotally connected to third support frame 56. Additionally, first support frame 52 may engage third support frame 56 via engagement members 60, while connectors 58 may be pivotally connected to the third support frame.

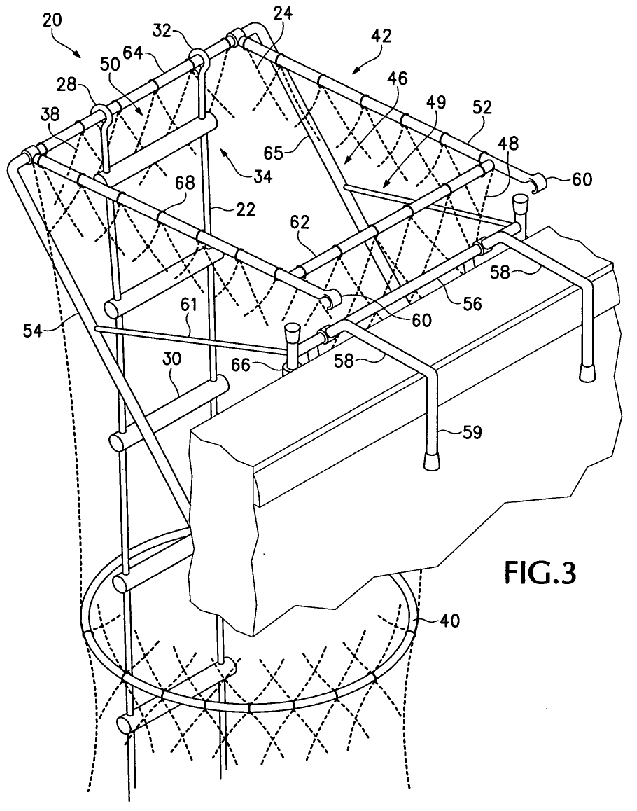

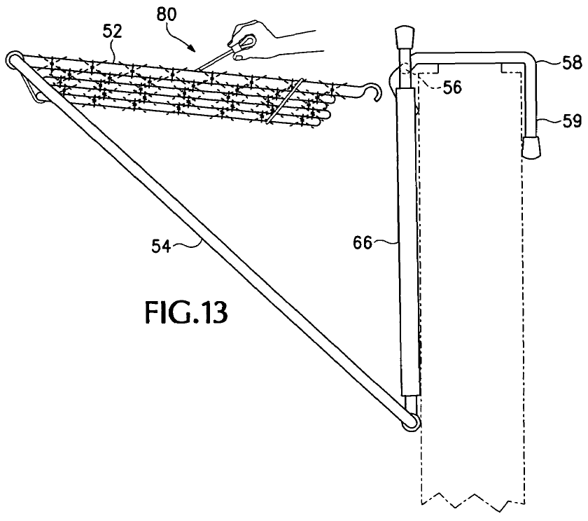

Second support frame 54 may additionally, or alternatively, be connected to third support frame via one or more connectors 61 (such as a rope), as shown in FIG. 3 (and, for the sake of clarity, omitted from FIGS. 13-15 discussed below). Connectors 61 may at least partially maintain the first, second, and/or third support frames in one or more desired positions, such as the positions described above. Those connectors may, for example, maintain first support frame 52 proximate to third support frame 56, as shown in FIG. 3, to facilitate engaging the first support frame with the third support frame via engagement members 60.

Although the first, second, and third support frames are shown to be rectangular, those support frames may be any suitable shape or combination of shapes. Additionally, although attachment mechanism 26 are shown to include support frames, the attachment mechanism may include any suitable structure configured to interact with the connectors to engage a ledge and/or other suitable portion of the upper-story window (and/or other access area). Moreover, although connectors 58 are shown to include hooks, the connectors may include any suitable structure configured to engage a ledge or sill of the upper-story window or opening. For example, connectors 58 may bolt, screw or otherwise mount directly on or beneath the lower window sill or bottom frame member of the opening, without resort to hooks, hinges or other intermediate structure.

Furthermore, although connectors 61 are shown to include a rope, the connectors may include any suitable structure configured to connect the second and third support frames, and/or any suitable combination of support frames. Additionally, although attachment mechanism 26 is shown to include three support frames, the attachment mechanism may include any suitable number of support frames.

One or more of the support frames may include one or more cushioning members 66, which may include any suitable structure configured to minimize scratching and/or other damage to the building structure (such as the window ledge or sill). For example, the cushioning members may include foam and/or rubber pads.

Although only third support frame 56 is shown to include cushioning members 62, any combination of support frames may include cushioning members. Additionally, although cushioning members 62 are shown to include foam pads, the cushioning members may include any suitable structure configured to minimize scratching and/or other damage to the building structure. It will be appreciated that any scratching or damage from the invented device is minimized by the use of a window-mounted support frame and a free-falling chute supported thereby. This is an advantage in any event over prior art escape ladders that require lateral support along their height from a wall of a building. The invented access device's lateral support-free configuration also makes it possible to use the access device on a wall having a window in it, which window would readily break if lateral support thereat were required to bear the weight of an escapee.

The attachment mechanism may support access structure 22 and containment structure 24 in any suitable way. For example, ladder 28 may be attached to distal bar 64 of first support frame 52. The ladder may be attached by tying support lines 32 around the distal bar, or via any suitable connector(s). Additionally, upper end portion 42 of chute 38 also may be attached to the first support frame. The chute may be attached via one or more connectors 68 (such as one or more ropes) around the first support frame. Thus, ladder 28 may extend along distal side 50 of chute 38 from upper end portion 42 to adjacent to lower end portion 44. The ladder's position along the distal side of the chute may minimize a user's contact with the building structure when the access device is being used.

Moreover, the ladder may be connected to the chute in one or more areas and at one or more intervals therealong. For example, one or more areas of the ladder may be connected to the chute via one or more tie wraps (not shown) or other suitable connectors. Alternatively, or additionally, the support lines of ladder 28 may be weaved in and out of chute 38. The connection between the ladder and the chute may allow for easy installation and storage of the access device without having the chute bear the weight of a user traversing the ladder (the ladder 28 and the attachment mechanism would bear such weight). For example, a user may retract the access device by simply retracting the chute or the ladder (instead of having to retract both independently).

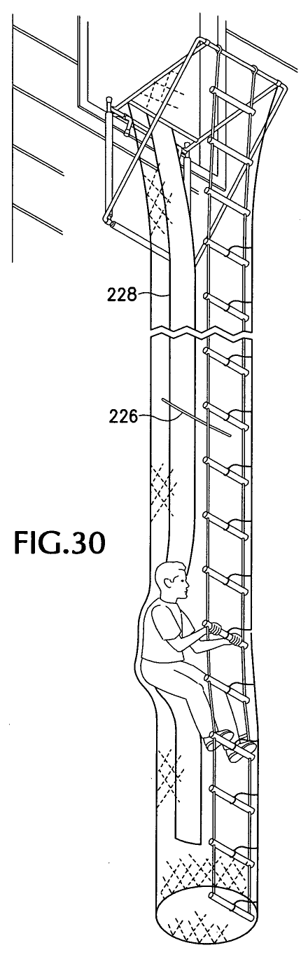

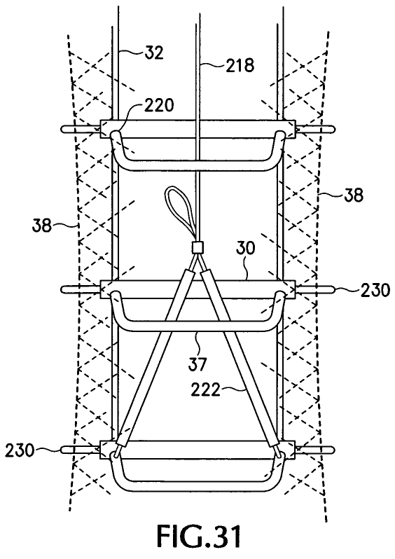

Tying or otherwise connecting the ladder to the interior of the chute also makes use of the access device easier and more secure. The chute and connected ladder cooperate with one another and with the user's body to render the access device useful without the segment rings or other form of support members 40. The user can ascend or descend the ladder with his or her hands and feet engaging a lower and upper rung of the ladder and with his or her backside propped against the opposite surface of the chute. This is best illustrated in FIGS. 30 and 31, to be discussed in more detail below.

On the other hand, it is helpful to deploy (release) and stow (retract) the chute and ladder independently to ensure proper deployment and stowage of each. Thus, the illustrated embodiments of the invented access device feature such independent deploy-ability, by way of physical separation along all but the very top of their lengthwise extents, of chute and ladder. This avoids undesirable interference between the two components of the access device, as by snagging.

Although ladder 28 is shown to be attached to distal bar 64, the ladder may be attached to any suitable portion(s) of the first support frame, or any suitable portion(s) of the attachment mechanism. For example, the ladder may be attached to proximal bar 62 or side bars 63 and 65. Additionally, although ladder 28 is tied to the first support frame, the ladder may be attached to the first support frame via any suitable connector(s). Moreover, although chute 38 is shown to be attached to the first support frame via a rope, the chute may be attached via tying and/or any suitable connector(s).

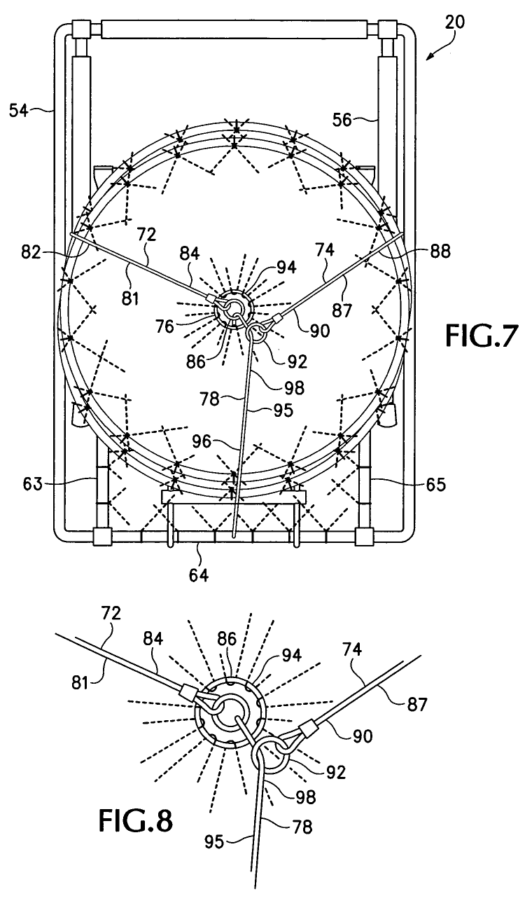

Access device 20 also may include a storage mechanism 70, which may include any suitable structure configured to store access structure 22, containment structure 24, and/or attachment mechanism 26. Additionally, or alternatively, the storage mechanism may include any suitable structure configured to allow a user to quickly deploy the access structure and/or the containment structure. For example, storage mechanism 70 may include a first restraint 72, a second restraint 74, a third restraint 76, and a fourth restraint 78, and a base 80, as shown in FIGS. 7-10. The first, second, third, and fourth restraints, and the base may be configured to interact to secure or restrain the access and containment structures to the attachment mechanism.

First restraint 72 may include a first cord 81, which may include a proximal end portion 82 and a distal end portion 84. Proximal end portion 82 may be attached to side bar 63, while distal end portion 84 may include a first receiver 86. The first receiver may include a ring and/or any suitable structure configured to receive a portion of fourth restraint 78. Second restraint 74 may include a second cord 87, which may include a proximal end portion 88 and a distal end portion 90. Proximal end portion 88 may be attached to side bar 65, while distal end portion 90 may include a second receiver 92. The second receiver may include a ring and/or any suitable structure configured to receive a portion of fourth restraint 78.

Although first and second receivers 86 and 92 are shown to include a ring, one or both of those receivers may include any suitable structure configured to receive a portion of fourth restraint 78. For example, one or both of those receivers may include a loop formed from cords 81 and/or 87. Additionally, although first and second restraints 72 and 74 are shown to include cords 81 and 87, one or both of those restraints may include any suitable structure configured to assist in securing the access and containment structures to the attachment mechanism.

Third restraint 76 may include a third receiver 94, such as a ring or loop, attached to lower end portion 44 of chute 38. In some embodiments, third receiver 88 also may at least substantially close the lower end portion to ensure that a user is contained within the chute in the event the user falls off, or otherwise becomes disengaged from, the access structure. Although third receiver is shown to include a ring, the third receiver may include any suitable structure configured to receive a portion of fourth restraint 78. For example, the netting of lower end portion 44 may be tied or otherwise arranged together to form third receiver 88.

Fourth restraint 78 may include a third cord 95, which may include a proximal end portion 96 and a distal end portion 98. Proximal end portion 96 may be attached to proximal bar 62 or distal bar 64, while distal end portion 98 may include a fourth receiver 100. The fourth receiver may include a loop, ring, and/or any suitable structure configured to engage a portion of the base.

Although fourth restraint 78 is shown to include third cord 95, the fourth restraint may include any suitable structure configured to be received in the first, second, and/or third receivers. Additionally, although the fourth receiver is shown to include a loop formed from third cord 95, the fourth receiver may include any suitable structure configured to engage a portion of the base. For example, fourth receiver 100 may include a ring sized to fit through the first, second, and/or third receivers.

Base 80 may include any suitable structure configured to receive fourth receiver 100 of fourth restraint 78. For example, base 80 may include an extension 102 having a notch 104 to receive the fourth receiver. The base may be attached to third support frame 56 or to any suitable portion of the attachment mechanism. Although base 80 is shown to include an extension 102 having a notch 104, the base may include any suitable structure configured to receive fourth receiver 100 of fourth restraint 78.

FIGS. 4-10 show an example of a method of storing access device 20. First, access structure 22 and containment structure 24 may be brought towards attachment mechanism 26, such as by moving support members 40 towards the attachment mechanism. Second, first support frame 52 may be disengaged from third support frame 56. Third, the first, second, and third support frames may be pivoted to a compact, collapsed position. Fourth, the first and second restraints may be brought towards third restraint 76. Fifth, the fourth receiver of the fourth restraint may be inserted through the first, second, and third restraints. Sixth, the fourth receiver of the fourth restraint may be engaged with base 80. However, the steps discussed above may be performed in different sequences and in different combinations, not all steps being required for all embodiments of the invented access and escape devices. For example, first support frame 52 may be disengaged from the third support frame before the access and containment structures may be brought towards the attachment mechanism.

FIGS. 11-16 show an example of a method of installing portable access device 20 on upper-story window 202. First, the access device may be positioned on the window such that connectors or anchors 58 may engage a ledge of the upper-story window. Second, once the connectors have engaged the ledge, the rest of the access device may be pushed outside of the upper-story window. Third, the fourth receiver of the fourth restraint is disengaged from base 80. Fourth, the first support frame is connected to the third support frame via engagement members 60. However, the steps discussed above may be performed in different sequences and in different combinations, not all steps being required for all embodiments of the access or escape devices.

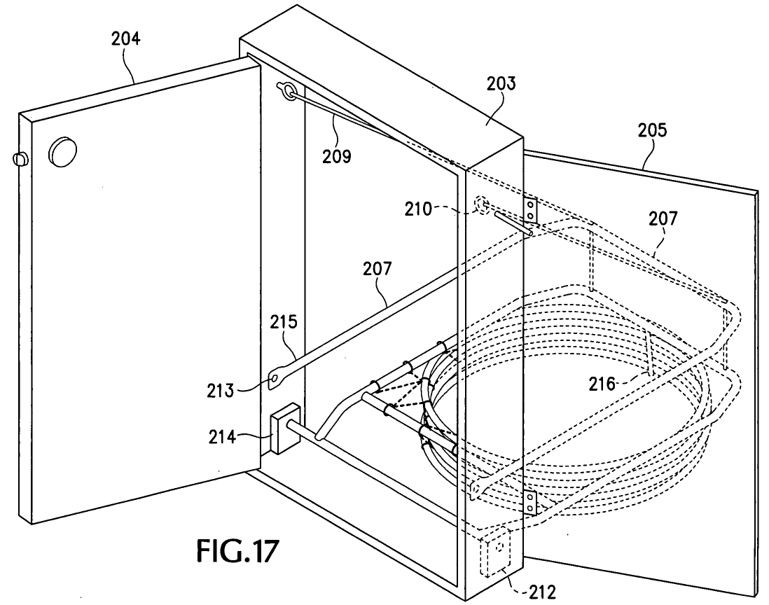

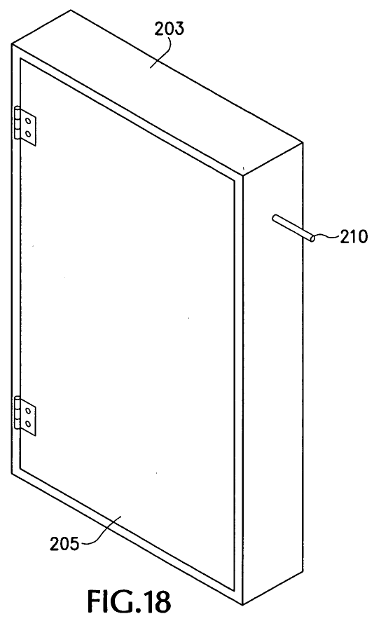

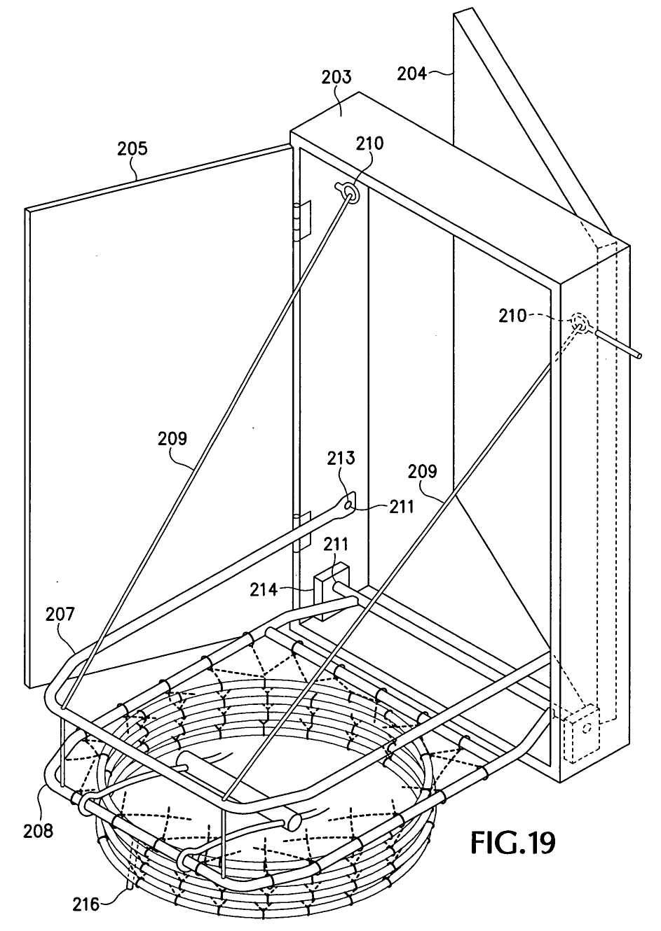

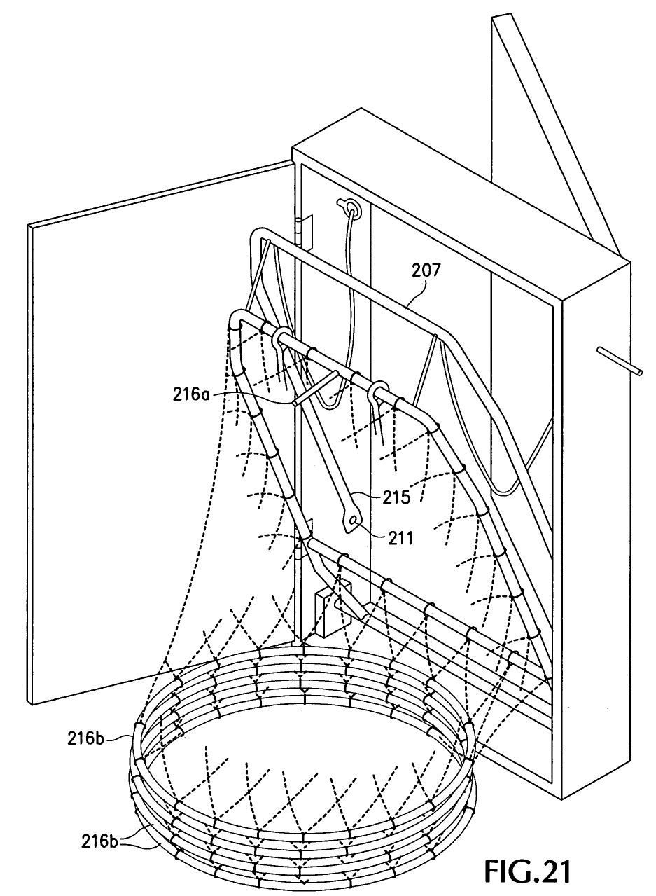

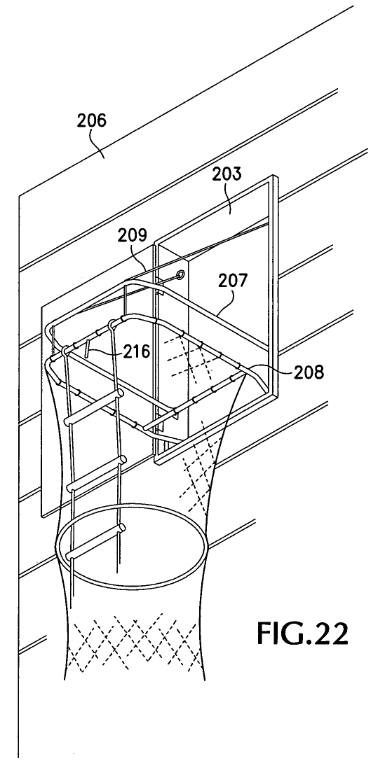

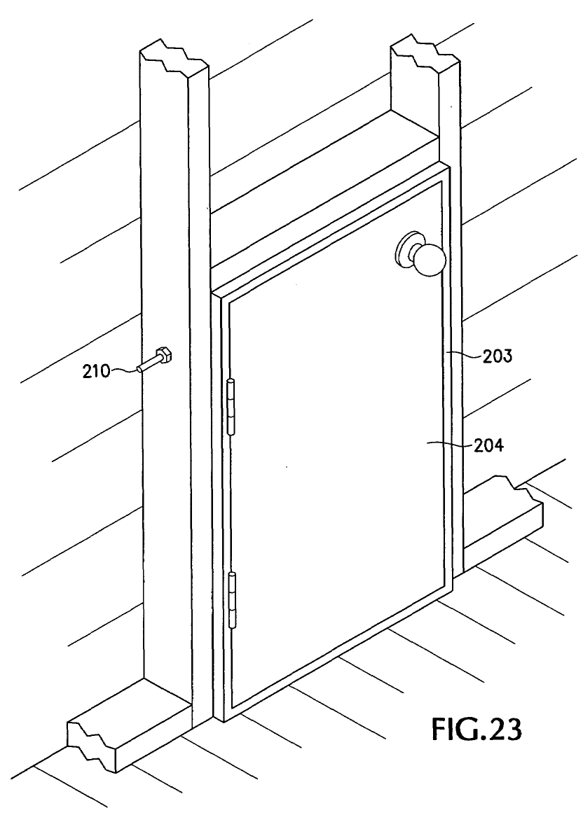

FIGS. 17-25 show another example of access device 20 mounted to another suitable access area 200. The chute 38 and ladder 28 may be housed in a door frame 203 between an inner door 204 and outer door 205. In the deployed configuration 206, the chute 38 and/or ladder 28 may be supported by a rail 207 and/or support 208. The support 208 and rail 207 may be supported by one or more support lines 209 that may be made of wire cable, rope, chain or other flexible material. The support lines 209 may be attached to the door frame 203 with a fastener 210. The pivot points may be held in place by a fastener 213 and/or a pivot block 214. The rail 207 and support 208 pivot points 211 may include a guard 215 to allow the user to move into the chute 38 without being arrested, for example by a item of clothing.

One or more ladder and chute rings or hoops (referred to herein as first and third catch members) may be provided or used to stow the ladder and chute. One or more ladder and chute posts or holders 216a and 216b (referred to herein respectively as second and fourth catch members) may be attached to the rail 207 or support 208 or both and allow the easy storage and deployment of the cute and ladder, as by the first catch member slidingly disengaging the second catch member and by the third catch member slidingly disengaging the fourth catch member as the frame is pivoted slightly outwardly from the opening. Those of skill in the art will appreciate that any suitable number, arrangement and location of the first, second, third, and fourth catch members is contemplated as being within the spirit and scope of the invention. For example, the ring or hoop and post can take the form of a loop of string and a nail, the hoop can have a ring or loop of string attached to an outer edge thereof to act as the third catch member, the second and fourth catch members may be combined into one for engagement with both the first and third catch members, etc.

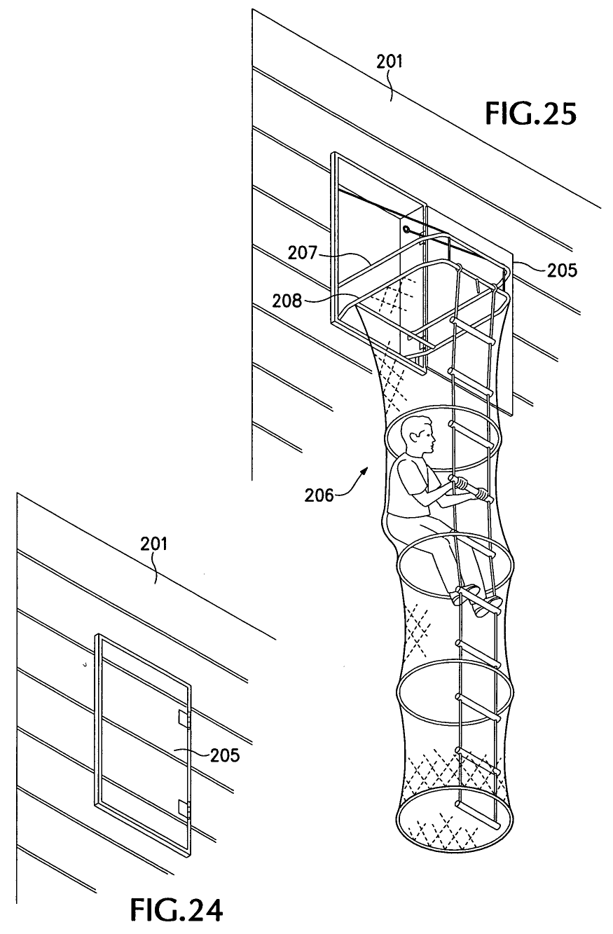

The inner and outer doors may have conventional hardware such as door knobs and locks and be configured to open left, right, or downward. From FIG. 24, it may be seen that, in accordance with one embodiment of the invented escape device 20, the outside surface of outer door 205 is substantially flush with the outside surface of building 201. Indeed, it is contemplated by the invention that outer door 205 is finished and painted with the same finish and paint as that of building 201. In this manner of constructing the escape device, it is substantially hidden from casual view. This is both utilitarian (an invisible door does not invite entry or otherwise raise security concerns) and aesthetic (an invisible door blends in with its surroundings and maintains the look and feel of the building, e.g. a house).

### 1) Ladder Steps

The ladder's steps or rungs are designed with three key features: 1) to deploy without tangling, 2) to push the netting away from the foot for better purchase on the rungs and 3) to guard against the user's toe or foot snagging the webbing after deployment.

The ends of the rungs are made to minimize the chance of a rung being caught in a mesh or tangled when the access device is deployed. This is done by inserting the supporting line and deflecting element 37 in the form of a stand-off adjacent the end of the rung such that there is no inward protrusion beyond the supporting line and stand-off. Referring briefly to FIGS. 26A and 26B, this is made possible in accordance with the third embodiment of the invention by providing a metal insert 217 to reinforce the rung end and by fixing either end of the curved stand-off therein so that the stand-off and any attachment hardware does not extend inwardly of the rung when the ladder is deployed.

Because the ladder supporting line is inserted through each rung, when force is applied to the line supporting the ladder, a moment is induced on the rung thus forcing the stand-off (and the netting) from a position of rest in an intermediate orientation of approximately 45° (see FIG. 26A) to a substantially horizontal orientation of approximately 90° orientation relative to the ladder (see FIG. 26B).

### 2) Hoop Shape

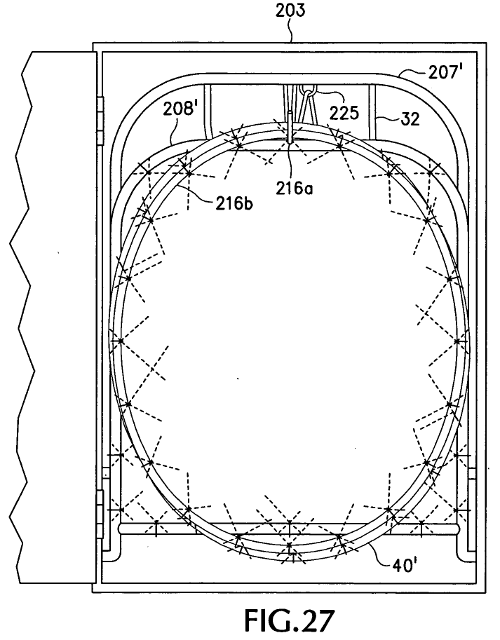

The shape of the hoops 40′ in accordance with the third embodiment of the invention shown in FIGS. 27-29 is narrower along one axis than along a perpendicular axis. Such can be realized within the spirit and scope of the invention by an elliptical or oval or otherwise eccentric curved shape having what is referred to as a major and minor axis. Such alternatively can be realized within the spirit and scope of the invention by a rectilinear or rectangular shape also having what is also referred to as a major (longer) and minor (shorter) axis, i.e. a longer and shorter side. This shape allows for a person of large girth to fit through a hoop and at the same time minimizes the distance between the user's back and the netting when descending. Minimizing this distance is important because when descending with one or no hands the back must be supported by the netting. An oval or elliptical or rectangular hoop shape also maximizes the hoop size to the size of the door frame opening. The door frame is designed to fit between standard sixteen inch (16″) on-center (OC) studs (32″ wide), and aligning the longer axis of the hoops vertically when the device is stowed permits an increase in the area circumscribed by the hoops. Thus, frame members 207′ and 208′ are in accordance with the third embodiment of the invention slightly more rounded, and are dimensioned to fit within the alternate studs-defined space, as shown.

Those of skill in the art will appreciate that the slightly elongated hoop shape also stabilizes the hoop better than would a circle or square, since the most natural inclination of the upper-most hoop when the chute is deployed is to come to rest with its longer side or surface against the wall of the building from which the device is deployed. This orientation also is the desired orientation from a girth-of-user standpoint, since it permits a larger user of the device to fit width-wise while stepping or sliding down the interior of the chute facing away from the building.

### 3) Deployment/Storage Features

A pull line 218, fastened onto the bottom rung and attached at the top rail through a first catch member 220, e.g. a ring, can be used to store the ladder. Pull line 218 can be connected to a triangular or other suitably configured lift 222 that is wider than the rungs to facilitate smooth stowage of the ladder, as shown. With the ladder deployed, when this line is pulled the ladder collapses into a compact bundle, the ring on this line engaging, as by sliding onto, a second catch member 224, e.g. a hook or angled post, such that when the ladder is deployed, the hook releases the ring, and in turn the line, and the ladder fully deploys by falling under its own weight within the chute. Those of skill in the art will appreciate that pull line 218 can be routed through a frame member-mounted ring 225, as shown, to facilitate elevation and stowage of the collapsed ladder.

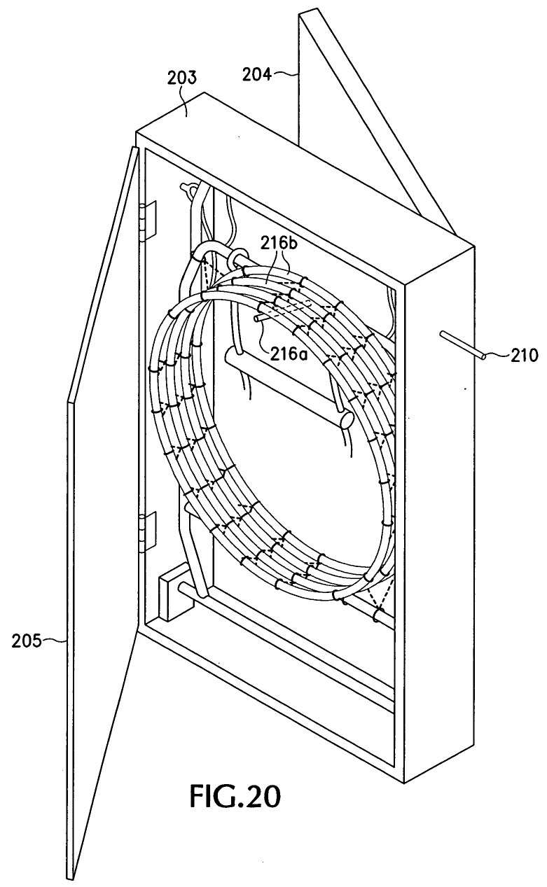

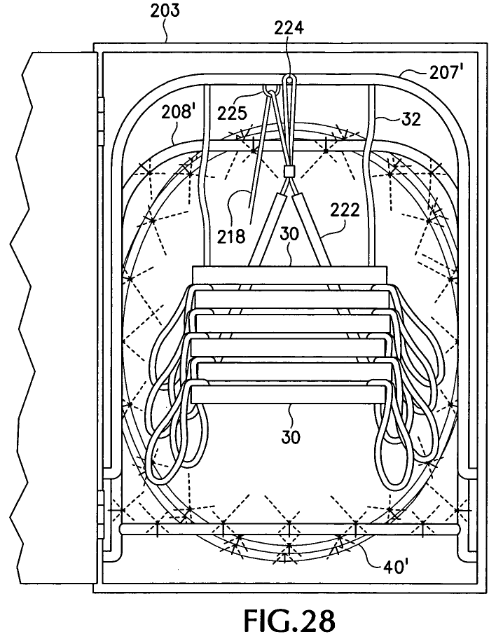

Third and fourth catch members 216a and 216b are visible in FIGS. 20, 21 and 28. Third catch member 216a takes the form of a post mounted to extend from frame member 208 at a slight angle, as illustrated, such that when frame member 208 is pivoted into a generally vertical stowage orientation, post 216a extends outwardly and slightly upwardly. Fourth catch member 216b can take any suitable form. It can be a loop or tie associated with one or more of support members 40 or can be simply support members 40 themselves, slidingly engageable with third catch member 216a, as shown in FIG. 28. Those of skill in the art will appreciate that the third and fourth catch members facilitate stowage and smooth deployment of the chute and ladder by securing the chute and ladder by the hoops and a pull ring while they are stowed and smoothly releasing them by sliding action while the frame is pivoted outwardly away from the opening of the upper story of the building or structure. The invention in accordance with one embodiment ensures that the chute deploys by the third and fourth catch members' sliding disengagement from one another, and thereafter the ladder deploys by the first and second catch members' sliding disengagement from one another, all in a smooth, gravity-assisted pivotal rotation of the frame form its stowed (vertical) orientation to its deployed (horizontal) orientation.

FIG. 30 shows the invention in accordance with a fourth embodiment. In this embodiment of the invention, the access device includes a frame, a chute and a ladder, but there are no support members 40. Such an embodiment nevertheless is surprisingly stable and useful in accessing an elevated structure or the ground or landing therebeneath. The chute and ladder therein are connected so that they work as one with one another and with the user's body when the user has his or her feet and hands on a lower and upper rung of the ladder and his or her backside pressing against the chute. The connection between chute and ladder can be any suitable arrangement of tying or other connection devices, whether semi-permanently or permanently, or only temporarily effective (refer briefly to FIG. 31, discussed below). In accordance with the illustrated embodiment, plural ties are interval spaced along the length of the elongate chute and ladder therein approximately intermediate the rungs of the ladder. Within the spirit and scope of the invention, any number or arrangement or style of ties can be used.

A user is shown within the chute and on the ladder, as described above, in the middle of his or her ascent or descent. A intermediate rest shoulder 226 is provided in accordance with this embodiment of the invention that provides some support for the user's backside. In accordance with one embodiment, shoulder 226 is formed by extending a cord across the interior of the chute such that it provides purchase for the user's backside, as illustrated. Such might be provided in other embodiments of the invention, especially when the access device must reach a high elevation. In some such applications of the invented access and escape devices, an extra pull line (not shown) can be provided for the chute, the pull line being tied to an intermediate hoop in those embodiments of the invention that include hoops, the pull line being tied to an intermediate chute location in those embodiments of the invention that do not include hoops, as shown.

Also shown in FIG. 30 is a flexible (collapsible) glide runner 228 extending at least partway down the length of the chute and within the chute's interior behind the user. Such a runner can be provided optionally with any of the embodiments described and illustrated herein to smooth a user's ascent or descent so that the user's backside glides without snagging along the inner rear surface of the chute.

FIG. 31 corresponds generally with FIG. 30, but shows in a fragmentary front elevation the ladder only temporarily connected to the chute by hooks 230 that extend laterally from each ladder rung. It will be understood that in this embodiment of the invention, with the weight of a user (not shown for the sake of clarity) on each successive rung of the ladder, the ladder in the region of such successive rungs angles naturally in response such that one or more hooked rungs above and below the load-bearing rung engages the netting of the chute and thus connects the ladder to the chute temporarily. In this manner, the user's weight forces the temporary connection that is needed to connect the two such that there is substantially no slippage of the ladder relative to the chute. Those of skill in the art will appreciate that, without the user's weight on a given rung or nearby rung, the rungs drape within the chute such that the hooks do not impinge on the netting of the chute. In this manner, the ladder (the lateral extent of which is less than the diameter or major axis of the chute) is freely deployed and stowed separately from the chute, substantially without interference by the laterally extending hooks.

From the foregoing, those of skill in the art will appreciate that several advantages of the present invention include the following.

The present invention provides many advantages over conventional access and escape devices. The invented device is durable but lightweight, and is easily installed, stowed, deployed and used. It provides hoops in some embodiments that slow a user's descent in a step-wise fashion yet are wide enough for users of wider girth. The stand-offs prevent snagging or catching a user's toes in the webbed material of the chute and are configured so as not to interfere with smooth deployment of the independent chute and ladder. The use of a hook and ring for stowing the ladder within the interior of the chute permits semi-automatic deployment of all. Packaging the chute and ladder with the frame within an opening in an interior wall of an elevated structure and closing the opening with an exterior and an interior door renders the escape device in accordance with one embodiment of the invention aesthetic as well as useful.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. An access device for ingress or egress to or from an elevated structure, the device comprising:
a generally elongate cylindrical chute defining a hollow interior having an upper open end and a lower end;
a frame attached to the upper open end of the chute, the frame including means adjacent a rear of the chute for mounting the same to an elevated structure; and
a ladder having plural steps spaced at intervals interior of and along the long axis of the chute, at least some of the plural steps being attached to the chute such that the ladder extends along an inner surface of a front of the chute.

2. The access device of claim 1, wherein plural steps are at least temporarily affixed to the chute at plural spaced apart intervals therealong.

3. The access device of claim 1, wherein the chute is configured to collapse along its elongate axis for stowing, wherein the chute is configured to elongate along its elongate axis for deploying, and wherein the frame is configured to be pivotally mounted adjacent an opening in the elevated structure with the chute stowed therein.

4. The access device of claim 1, wherein the lower end of the hollow interior of the chute is normally generally closed but is openable.

5. The access device of claim 1, wherein the lower end of the hollow interior of the chute is normally open but is generally closeable.

6. The access device of claim 1, wherein the lower end of the hollow interior of the chute is generally closed.

7. The access device of claim 1, wherein the lower end of the hollow interior of the chute is open.

8. The access device of claim 1, wherein at least some of the plural steps of the ladder include a pivotal stand-off structure that deflects the net away from the at least some steps in a vicinity above and below the at least some steps when the at least some of the plural steps are stepped on by a user.

9. The access device of claim 8, wherein the stand-off structure of the at least some of the plural steps is configured with a smooth outer curve.

10. An access device for ingress or egress to or from an elevated structure, the device comprising:
a generally elongate cylindrical chute configured to collapse along its elongate axis for stowing and configured to elongate along its elongate axis for deploying, the chute including plural rigid hoops connected thereto in parallel alignment with one another and in spaced apart locations along the elongate axis of the chute, the plural hoops having a minor axis and a major axis substantially greater than the minor axis, the plural hoops maintaining the generally elongate cylindrical shape of the chute when deployed, the plural hoops further providing step-wise support for the body of a user therein, the chute defining a hollow interior having an upper open end and a lower end; and
a frame attached adjacent the upper open end of the chute above an uppermost one of the plural hoops, the frame configured to be mounted to an elevated structure adjacent an opening formed therein.

11. The device of claim 10 which further comprises:
a step ladder deployable within the cylindrical chute along an outer periphery thereof when the chute is deployed, the step ladder extending from a region adjacent the upper end to a region adjacent the lower end of the hollow interior defined by the chute.

12. The device of claim 11, wherein the step ladder includes plural spaced apart rungs, at least one rung having a stand-off coupled thereto for spacing an adjacent portion of the chute outwardly away from the at least one rung when the step ladder is deployed within the deployed chute.

13. The device of claim 12, wherein the step ladder further includes pairs of flexible tethers extending between adjacent ones of the plural spaced apart rungs, and wherein the stand-off coupled to the at least one rung is fixedly connected to the at least one rung such that the stand-off leverages the adjacent portion of the chute outwardly away from the at least one rung when the at least one rung is stepped on by a user.

14. The device of claim 13, wherein the pairs of flexible tethers extend through either end of the at least one rung.

15. The device of claim 14 in which the at least one rung is made of a hollow lightweight flexible generally cylindrical tube and in which the at least one rung has holes on either end thereof through which a corresponding pair of flexible tethers extend, wherein the at least one rung has a pair of metal reinforcement inserts on either end thereof, each of the pair of inserts having a hole formed therethrough in alignment with corresponding ones of the holes in either end of the cylindrical tube.

16. The device of claim 15, wherein the frame is configured to pivot relative to the elevated structure into a generally vertical stowed position and into a generally horizontal deployed position; and wherein the pivotable frame, the chute and the step ladder when collapsed with the frame so pivoted into the stowed position collectively are configured to be stowed substantially within an interior wall of the elevated structure.

17. The device of claim 16, wherein the pivotal frame is hinged along its base such that the frame pivots outwardly from the elevated structure from a stowed position within an interior wall thereof to a deployed position thereof in which the chute and step ladder therein at least semi-automatically deploy by application of a light outward force.

18. The device of claim 17 which further comprises:
an openable exterior door mounted immediately exterior of the stowed position of the frame, chute and step ladder, the exterior door configured when the device is stowed to close the opening in the elevated structure and substantially to hide the access device from casual external view.

19. The device of claim 18 which further comprises:
an openable interior door mounted immediately interior of the stowed position of the frame, chute and step ladder, the interior door configured when the device is stowed further to close the opening in the elevated structure and substantially further to hide the access device from casual internal view.

20. The device of claim 19, wherein the stand-off is configured with a smooth outer curve.

21. The device of claim 20, wherein the opening is an upper-story window, wherein the frame is configured to mount on a sill of the upper window, and wherein the device is deployable by positioning the device with the frame captured in a cantilever position on the window sill and extending outwardly from the window.

22. An escape device for use on an upper floor of a building, the device comprising:
a generally elongate cylindrical chute configured to collapse along its elongate axis for stowing and configured to elongate along its elongate axis for deploying, the chute having a lower end and upper open end, the chute defining a hollow interior having an upper open end and a lower end, and
a frame attached to the upper open end of the chute, the frame configured to be mounted to an elevated structure adjacent an opening formed therein, wherein the frame is configured to pivot relative to the elevated structure into a generally horizontal deployment position and into a generally vertical stowage position, and wherein the pivotable frame and the chute, when collapsed with the frame pivoted into the stowage position, collectively are configured to be stowed substantially within an interior wall of the elevated structure.

23. The device of claim 22 which further comprises:
a step ladder deployable within the cylindrical chute along an outer periphery thereof when the chute is deployed, the step ladder extending from a region adjacent the upper end to a region adjacent the lower end of the hollow interior defined by the chute, wherein the step ladder includes plural spaced apart rungs, at least one rung having a stand-off coupled thereto for spacing an adjacent portion of the chute outwardly away from the at least one rung when the step ladder is deployed within the deployed chute, wherein the pivotable frame, the chute and the step ladder when collapsed with the frame so pivoted collectively are configured to be stowed substantially within an interior wall of the elevated structure.

24. The device of claim 23, wherein the chute includes a substantially open webbed material, and wherein at least one rung has a pair of opposing hooks each extending laterally outwardly from a corresponding end of the at least one rung, the hooks configured for at least temporary affixing engagement with the webbed material of the chute such that there is substantially no relative movement between the ladder and the chute in the vicinity of the at least one rung having the hooks.

25. The device of claim 24 which further comprises:
plural rigid hoops connected to the chute in parallel alignment with one another and in spaced apart locations along the elongate axis of the chute,
wherein a first pull line connected at one end thereof adjacent a bottom of the step ladder is equipped with a first catch member, wherein a proximal region of the pivotal frame includes a hinge, and wherein a distal region of the pivotal frame includes a second catch member configured slidably to engage the first catch member, wherein a second pull line connected at one end thereof adjacent one of the plural rigid hoops is equipped with a third catch member, wherein the distal region of the pivotal frame includes a fourth catch member configured slidably to engage the third catch member, whereby the frame pivoted into a generally vertical stowed position within an interior wall of the building maintains the first catch member relative to the second catch member and the third catch member relative to the fourth catch member, and whereby the frame pivoted slightly outwardly from the stowed position pivots the second catch member to slidingly release the first catch member and the further pivots the fourth catch member to slidingly release the third catch member as the frame begins to pivot into the deployed position thereof in which the chute and step ladder therein at least semi-automatically deploy.

26. The device of claim 25 which further comprises:
an openable exterior door mounted immediately exterior of the stowed position of the frame, chute and step ladder, the exterior door configured when the device is stowed to close the opening in the elevated structure and substantially to hide the access device from casual exterior view.

27. The device of claim 26 which further comprises:
an openable interior door mounted immediately interior of the stowed position of the frame, chute and step ladder, the interior door configured when the device is stowed also to close the opening in the elevated structure and substantially also to hide the access device from casual interior view.

28. The device of claim 27, wherein the exterior door when closed is substantially flush with an external wall of the building.

29. The device of claim 28, wherein the stand-off is configured with a smooth outer curve.

30. An access device for ingress or egress to or from an elevated structure, the device comprising:
a generally elongate cylindrical chute configured to collapse along its elongate axis for stowing and configured to elongate along its elongate axis for deploying, the chute including a flexible outer web and plural rigid hoops connected thereto in parallel alignment with one another and in spaced apart locations along the web and along the elongate axis of the chute, the plural hoops maintaining the generally elongate cylindrical shape of the chute when deployed, the plural hoops further providing step-wise support for the body of a user therein, the chute defining a hollow interior having an upper open end and a lower end;
a frame attached to the upper open end of the web above an uppermost one of the plural hoops, the frame configured to be mounted to an elevated structure adjacent an opening formed therein; and
a step ladder deployable within the cylindrical chute along an outer periphery thereof when the chute is deployed, the step ladder extending from a region adjacent the upper end to a region adjacent the lower end of the hollow interior defined by the chute.

31. The device of claim 30, wherein the step ladder includes plural spaced apart rungs, at least one rung having a stand-off coupled thereto for spacing an adjacent portion of the web outwardly away from the at least one rung when the step ladder is deployed within the deployed chute.

32. The device of claim 31, wherein the step ladder further includes pairs of flexible tethers extending between adjacent ones of the plural spaced apart rungs, and wherein the stand-off coupled to the at least one rung is fixedly connected to the at least one rung such that the stand-off leverages the adjacent portion of the web outwardly away from the at least one rung.

33. The device of claim 32, wherein the pairs of flexible tethers extend through either end of the at least one rung.

34. The device of claim 33 in which the at least one rung is made of a hollow lightweight flexible generally cylindrical tube and in which the at least one rung has holes on either end thereof through which a corresponding pair of flexible tethers extend, wherein the at least one rung has a pair of metal reinforcement inserts on either end thereof, each of the pair of inserts having a hole formed therethrough in alignment with corresponding ones of the holes in either end of the cylindrical tube.

35. The device of claim 34, wherein the frame is configured to pivot relative to the elevated structure into a generally vertical position, and wherein the pivotable frame, the chute and the step ladder when collapsed with the frame so pivoted collectively are configured to be stowed substantially within an interior wall of the elevated structure.

36. The device of claim 35 which further comprises:
a pull line engaging a bottom one of the plural spaced apart rungs, the pull line including a ring for slipping over a hook when the step ladder is stowed,
wherein the frame includes a post for securing the ring when the step ladder is stowed, the post being configured to enable the ring to slip there-off as the frame is pivoted during deployment of the access device.

37. The device of claim 36 which further comprises:
an openable exterior door mounted immediately exterior of the stowed position of the frame, chute and step ladder, the exterior door configured when the device is stowed to close the opening in the elevated structure and substantially to hide the access device from casual view.

38. The device of claim 37, wherein the stand-off is configured with a smooth outer curve.

39. A deployable access device for egress from an elevated structure, the device comprising:
a generally elongate cylindrical chute configured to collapse along its elongate axis for stowing and configured to elongate along its elongate axis for deploying, the chute including a flexible outer web and plural rigid hoops connected thereto in parallel alignment with one another and in spaced apart locations along the web and along the elongate axis of the chute, the plural hoops maintaining the generally elongate cylindrical shape of the chute when deployed, the plural hoops further providing step-wise support for the body of a user therein, the chute defining a hollow interior having an upper open end and a lower end;
a frame attached to the upper open end of the web above an uppermost one of the plural hoops, the frame including one or more anchor members for extending over and around a window sill of the elevated structure to anchor the frame to the elevated structure, the frame including a frame member for attaching the upper open end of the chute, the frame member being deployable in a generally horizontal plane extending at approximately the height of the window sill such that the chute extends downwardly therefrom along a generally vertical axis; and
a step ladder deployable within the cylindrical chute along an outer periphery thereof when the chute is deployed, the step ladder extending from a region adjacent the upper end to a region adjacent the lower end of the hollow interior defined by the chute,
the step ladder and the chute being collapsible generally into the plane of the frame such that the device is portable to a window sill by a person inside the elevated structure and deployable outside the window sill for egress therefrom to a landing therebelow.
